(19) United States
(12) Patent Application Publication
(10) Pub. No.: US 2009/0294241 A1
(43) Pub. Date: Dec. 3, 2009

(54) LUBRICANT DISCHARGING MECHANISM OF CLUTCH APPARATUS FOR TRANSMISSION

(75) Inventor: Tomohiro ARAKAWA, Nishio-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI CO., LTD., Nishio-shi (JP)

(21) Appl. No.: 12/473,848

(22) Filed: May 28, 2009

(30) Foreign Application Priority Data
May 29, 2008 (JP) 2008-141011

(51) Int. Cl. F16D 13/74

(52) U.S. Cl. 192/113.3

(57) ABSTRACT

A lubricant discharging mechanism of a clutch apparatus for a transmission, which includes the clutch apparatus having at least one clutch mechanism provided in a clutch housing defined in a transmission case and a gear train provided in a gear train housing defined in the transmission case adjacent to the clutch housing, includes a retainer, a bore, and a guide member. The retainer is provided inside the clutch housing to surround the clutch mechanism for retaining therein a lubricant for lubricating and cooling the clutch mechanism. The bore is formed at an outer circumferential portion of the retainer for discharging therethrough the lubricant lifted radially outwardly by a centrifugal force generated by a rotation of the clutch mechanism to an outside of the retainer. The guide member is connected to the retainer for guiding the lubricant discharged from the retainer towards the gear train.

### CROSS REFERENCE TO RELATED APPLICATIONS

This application is based on and claims priority under 35 U.S.C. §119 to Japanese Patent Application 2008-141011, filed on May 29, 2008, the entire content of which is incorporated herein by reference.

### FIELD OF THE INVENTION

The present invention relates to a lubricant discharging mechanism of a clutch apparatus for a transmission.

### BACKGROUND

As an example of a transmission including a clutch mechanism, JP2005-98409A (hereinafter, referred to as reference 1) and JP2006-132562A (hereinafter, referred to as reference 2) disclose a transmission having plural clutch mechanisms, each of which is operated to be in an engaged state and in a released state, and a gear train including plural input shafts which are respectively connected to the clutch mechanisms. When one of the clutch mechanisms is in an engaged state, a torque transmitting path is established through the corresponding input shaft. On the other hand, when one of the clutch mechanisms is in a released state, the torque transmitting path through the corresponding input shaft is interrupted. An inside of a transmission casing is divided into plural chambers to define a clutch housing and a gear train casing. The clutch mechanisms are housed in the clutch housing, while the gear train is housed in the gear train casing. Such transmission is known as the dual clutch type transmission, for example.

Specifically in such transmission having plural clutch mechanisms (clutch packs) such as the dual clutch type transmission, the clutch mechanisms (clutch packs) are densely provided in the clutch housing. Accordingly, a lubricant for lubricating and cooling the clutch packs is accumulated in a bottom space of the clutch housing, thus increasing an agitation resistance of the clutch mechanisms.

A need thus exists for a lubricant discharging mechanism of a clutch apparatus for a transmission which is not susceptible to the drawback mentioned above.

### SUMMARY OF THE INVENTION

According to an aspect of the present invention, a lubricant discharging mechanism of a clutch apparatus for a transmission, which includes the clutch apparatus having at least one clutch mechanism provided in a clutch housing defined in a transmission case and a gear train provided in a gear train housing defined in the transmission case adjacent to the clutch housing, includes a retainer, a bore, and a guide member. The retainer is provided inside the clutch housing to surround the clutch mechanism for retaining therein a lubricant for lubricating and cooling the clutch mechanism. The bore is formed at an outer circumferential portion of the retainer for discharging therethrough the lubricant lifted radially outwardly by a centrifugal force generated by a rotation of the clutch mechanism to an outside of the retainer. The guide member is connected to the retainer for guiding the lubricant discharged from the retainer towards the gear train.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a cross sectional view illustrating a lubricant discharging mechanism of a clutch apparatus, seen in an axial direction;

FIG. 2 is a schematic cross sectional view taken along line II-II in FIG. 1; and

FIG. 3 is a side view of a retainer of the lubricant discharging mechanism of the clutch apparatus illustrated in FIG. 2.

### DETAILED DESCRIPTION

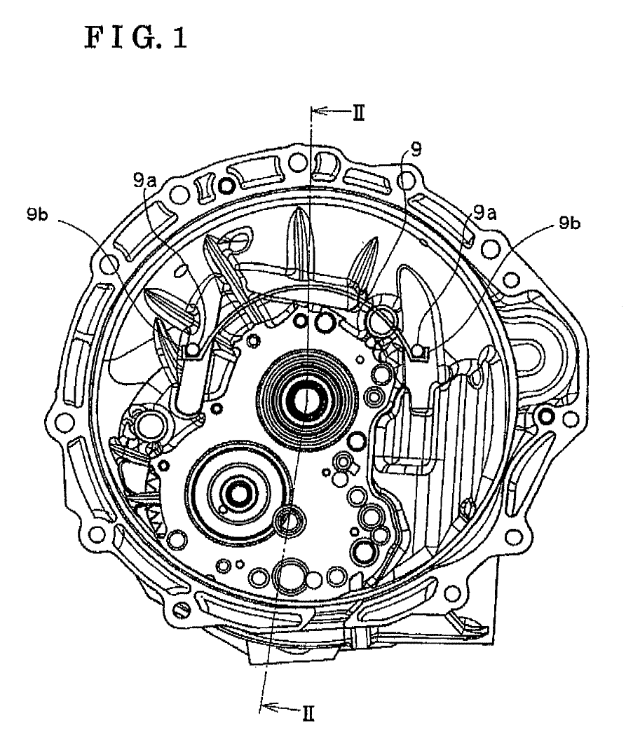

An embodiment of the present invention will be described hereinbelow with reference to FIGS. 1 to 3.

According to the embodiment, a dual clutch type transmission is employed as an example of a transmission. The dual clutch type transmission includes first and second clutch mechanisms (clutch packs) 4, 5 and a gear train G. An inside of a transmission case 1 of the transmission is divided into plural chambers to define a clutch housing 2 and a gear train casing 3. The first and second clutch mechanisms 4 and 5 are housed in the clutch housing 2, while the gear train G is housed in the gear train casing 3. According to the embodiment, a multiplate wet clutch is employed as each of the first and second clutch mechanisms 4 and 5, for example. Each of the first and second clutch mechanisms 4 and 5 is operated to be in an engaged state and in a released state. The gear train G includes a first input shaft 6 and a second input shaft 7, which are connected to the first and second clutch mechanisms 4 and 5, respectively. When one of the first and second clutch mechanisms 4 and 5 is in the engaged state, a torque transmitting path is established through the corresponding input shaft 6 or 7. When one of the first and second clutch mechanisms 4 and 5 is in a released state, the torque transmitting path through the corresponding input shaft 6 or 7 is interrupted. Thus, the gear train G is connectable and disconnectable to and from the corresponding first or second clutch mechanism 4 or 5. The clutch housing 2 and the gear train casing 3 are separated by a separator 1a provided inside the transmission case 1.

A driving torque is transmitted to the first and second clutch mechanisms 4 and 5 directly or indirectly from a power source (such as an engine and a motor). The gear train G includes a structure where plural gear sets are mounted, so as to be in parallel with each other, on the first and second input shafts 6 and 7. The plural gear sets are selectively connected to the corresponding first or second input shaft 6 or 7, so that the gear train G is connectable and disconnectable to and from the corresponding first and second clutch mechanisms 4 and 5. The driving torque from the power source is accordingly transmitted to an output shaft included in the gear train G via one of the gear sets and the corresponding first or second input shafts 6 or 7. When shifting gear stages, the torque transmitting path (a first torque transmitting path) through the first clutch mechanism 4 and the first input shaft 6 and the torque transmitting path (a second torque transmitting path) through the second clutch mechanism 5 and the second input shaft 7 are alternately established. Thus, a smooth and rapid speed changing operation is performed.

According to the embodiment, the lubricant discharging mechanism of the clutch apparatus includes a retainer 8, plural bores 8a and a guide member 9. The retainer 8 is provided inside the clutch housing 2 so as to surround the first and second clutch mechanisms 4 and 5. The retainer 8 retains therein a lubricant for lubricating and cooling the first and second clutch mechanisms 4 and 5. The plural bores 8a are formed at an outer circumferential portion of the retainer 8. When one of the first and second clutch mechanisms 4 and 5 rotates, the lubricant is lifted (splashed) radially outwardly by a centrifugal force generated by a rotation of one of the first and second clutch mechanisms 4 and 5. The splashed lubricant is discharged from the retainer 8 to an outside thereof through the bores 8a. The guide member 9 is connected to the retainer 8 for guiding the lubricant discharged from the bores 8a towards the gear train G.

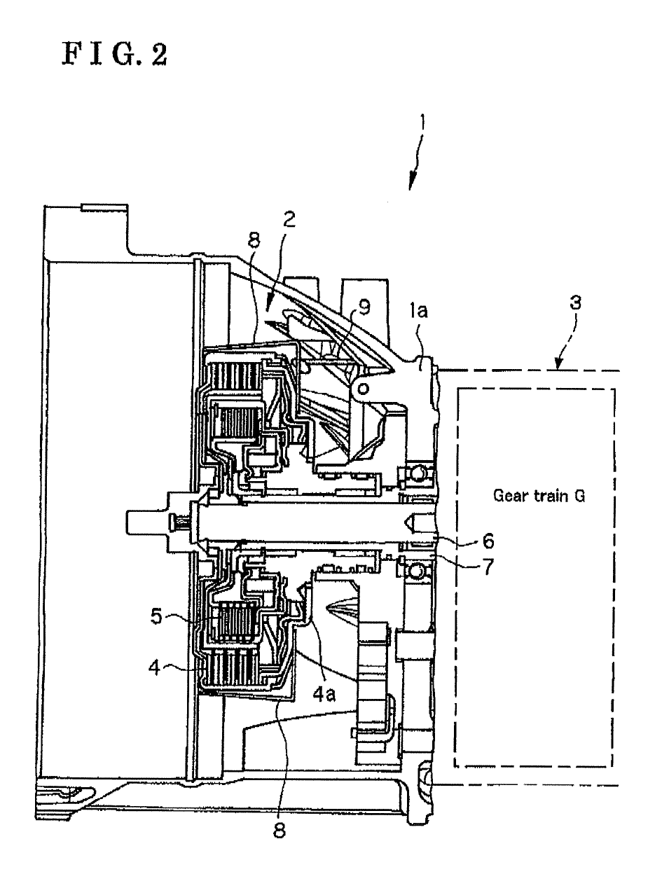

The retainer 8 includes a conical shaped inside space (specifically, frustoconical shaped inside space), which is formed to be narrower from a right side to a left side in FIG. 2. In other words, a narrower side of the conical shaped inside space of the retainer 8 is oriented to the first and second clutch mechanisms 4 and 5, while a wider side of the conical shaped inside space of the retainer 8 is oriented to the gear train G. The first and second clutch mechanisms 4 and 5 are located inside such conical spaced inside space of the retainer 8.

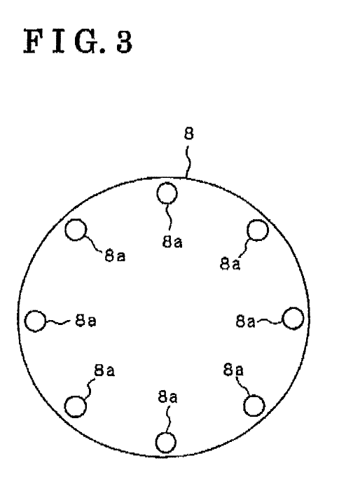

The first clutch mechanism 4 is provided at an outer circumferential side of the second clutch mechanism 5, and a clutch drum 4a is provided at an outer circumferential side of the first clutch mechanism 4. The retainer 8 is assembled onto the clutch drum 4a. Further, as illustrated in FIG. 3, the bores 8a are formed at the outer circumferential portion of the retainer 8 along an outer circumference of the first clutch mechanism 4 (i.e., an outer circumference of the second clutch mechanism 5 provided at an inner circumferential side of the first clutch mechanism 5), while distanced from the adjacent bores 8a.

The guide member 9 is provided at an outside of the retainer 8 in the clutch housing 2 so as to be adjacent to the gear train G. The guide member 9 extends in an axial direction of the first and second input shafts 6 and 7 from the retainer 8 to the separator 1a. More specifically, the guide member 9 is slightly sloped downwardly from the retainer 8 towards the separator 1a for guiding the lubricant towards the gear train G. Further, the guide member 9 is formed in an arch shape in a circumferential direction of the first and second clutch mechanisms 4 and 5. Such arc shaped guide member 9 is located at an upper side of the first and second input shafts 6 and 7 and at a lower side of some of the bores 8a formed at an upper circumferential side portion of the retainer 8 (i.e., some of the bores 8a located at an upper side of the first and second input shafts 6 and 7). Discharging openings 9a are formed at the separator 1a at positions respectively corresponding to both end portions (end portions in a circumferential direction) of the arc shape of the guide member 9. Still further, gutter portions 9b are formed at the end portions of the arc shape of the guide member 9, respectively. Accordingly, the gutter portions 9b respectively face the discharge openings 9a formed at the separator 1a. The lubricant lifted (splashed) radially outwardly by the first and second clutch mechanisms 4 and 5 is discharged from the retainer 8 through the bores 8a and is received by the guide member 9 and the gutter portions 9b thereof. Then, the lubricant is guided to the gear train G and is discharged thereto through the discharging openings 9a.

Hereinafter, utilization of the lubricant provided at the lubricant discharging mechanism of the clutch apparatus will be described hereinbelow.

When the driving torque of the power source is transmitted to one of the first and second clutch mechanisms 4 and 5, the lubricant (coolant) retained in the retainer 8 is lifted (splashed) radially outwardly towards the outer circumferential portion of the retainer 8 by the centrifugal force generated by the rotation of one of the first and second clutch mechanisms 4 and 5. Further, the splashed lubricant is discharged from the retainer 8 through the bores 8a formed at the outer circumferential portion of the retainer 8. Then, the lubricant discharged on the guide member 9 in favor of gravity flows on a surface of the guide member 9 and in the gutter portions 9b. Thus, the lubricant is guided to the gear train casing 3 through the discharge openings 9a, thereby lubricating the gear train G. Due to the lubricant discharging mechanism according to the embodiment, the lubricant is prevented from being excessively accumulated in the retainer 8, so that the agitation resistance of the first and second clutch mechanisms 4 and 5 is prevented from increasing. Still further, the lubricant (coolant) is satisfactorily supplied to the gear train G.

According to the embodiment described above, the retainer 8 includes the plural bores 8a. However, the retainer 8 may include one bore 8a for discharging therethrough the lubricant from the retainer 8.

Further according to the embodiment, the clutch mechanism includes the first clutch mechanism 4 operated to be in the engaged state and the released state, and the second clutch mechanism 5 operated to be in the engaged state and the released state. Further, the gear train G includes the first input shaft 6 through which a torque is inputted from the first clutch mechanism 4 when the first clutch mechanism 4 is in the engaged state, and the second input shaft 7 through which the torque is inputted from the second clutch mechanism 5 when the second clutch mechanism 5 is in the engaged state thereof.

Thus, the above described structure is specifically applicable to the transmission including the plural clutch mechanisms (first and second clutch mechanisms 4 and 5), in which components thereof are densely provided in the clutch housing 2. Due to the above described lubricant discharging mechanism, an excessive amount of lubricant is effectively discharged from the clutch housing 2 even in such dense structure.

Still further according to the embodiment, the retainer 8 includes the conical shaped inside space (frustoconical shaped inside space). Further, the narrower side of the conical shaped inside space of the retainer 8 is oriented to the clutch mechanisms 4 and 5 and the wider side of the conical shaped inside space of the retainer 8 is oriented to the gear train G. The clutch mechanisms 4 and 5 are provided inside the conical shaped inside space of the retainer 8.

Due to the above described structure, the lubricant lifted radially outwardly is effectively guided to flow along the inner circumferential surface of the retainer 8 to the bores 8a by the centrifugal force generated by the rotations of the clutch mechanisms 4 and 5.

Still further according to the embodiment, the plural bores 8a are formed at the outer circumferential portion of the retainer 8 along the outer circumference of the clutch mechanisms 4 and 5.

Due to the above described structure, because the plural bores 8a are formed at the retainer 8 along the outer circumference of the first and second clutch mechanisms 4 and 5, the lubricant is further effectively discharged from the retainer 8. Still further, plural bores 8a are located at the upper side of the guide member 9. Accordingly, the greater amount of lubricant is received by the guide member 9, thereby further effectively supplying the lubricant to the gear train G.

Still further according to the embodiment, the clutch drum 4a is provided at the outer circumferential side of the clutch mechanisms 4 and 5, and the retainer 8 is assembled onto the clutch drum 4a.

Due to the above described structure, the lubricant discharging mechanism is easily assembled onto the transmission with a simple structure.

[ [symbol] 6 [symbol] ] Still further according to the embodiment, the guide member 9 is provided at the outside of the retainer 8 so as to extend from the retainer 8 to the separator 1a dividing the transmission case 1 to the clutch housing 2 and the gear train housing 3 and is located at the lower side of the bores 8a of the retainer 8. The guide member 9 includes the arc shape in the circumferential direction of the clutch mechanisms 4 and 5. Further, the plurality of discharge openings 9a is formed at the separator 1a at the positions respectively corresponding to both end portions of the arc shape of the guide member 9.

Still further, the guide member 9 further includes the plurality of gutter portions 9b respectively provided at the end portions of the arc shape of the guide member 9 and extending from the retainer 8 to the separator 1a. The plurality of gutter portions 9b respectively faces the plurality of discharge openings 9a. Accordingly, the lubricant discharged from the retainer 8 through the bore 8a is received by the gutter portions 9b of the guide member 9 to be guided towards the gear train G and is supplied to the gear train G through the discharge openings 9a.

Due to the above described structure, the size of the guide member 9 is arranged to be the minimum.

Still further, the bore 8a formed at the outer circumferential portion of the retainer 8 is located at the upper side of the input shafts 6 and 7 of the gear train G, and the guide member 9 connected to the retainer 8 is located at the upper side of the input shafts 6 and 7 and at the lower side of the bore 8a of the retainer 8.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A lubricant discharging mechanism of a clutch apparatus for a transmission, the transmission including the clutch apparatus having at least one clutch mechanism provided in a clutch housing defined in a transmission case and a gear train provided in a gear train housing defined in the transmission case adjacent to the clutch housing, the lubricant discharging mechanism comprising:
a retainer provided inside the clutch housing to surround the clutch mechanism for retaining therein a lubricant for lubricating and cooling the clutch mechanism;
a bore formed at an outer circumferential portion of the retainer for discharging therethrough the lubricant lifted radially outwardly by a centrifugal force generated by a rotation of the clutch mechanism to an outside of the retainer; and
a guide member connected to the retainer for guiding the lubricant discharged from the retainer towards the gear train.

2. A lubricant discharging mechanism of a clutch apparatus for a transmission according to claim 1, wherein
the clutch mechanism includes a first clutch mechanism operated to be in an engaged state and a released state, and a second clutch mechanism operated to be in an engaged state and a released state,
the gear train includes a first input shaft through which a torque is inputted from the first clutch mechanism when the first clutch mechanism is in the engaged state, and a second input shaft through which the torque is inputted from the second clutch mechanism when the second clutch mechanism is in the engaged state thereof.

3. A lubricant discharging mechanism of a clutch apparatus for a transmission according to claim 1, wherein
the retainer includes a conical shaped inside space,
a narrower side of the conical shaped inside space of the retainer is oriented to the clutch mechanism and a wider side of the conical shaped inside space of the retainer is oriented to the gear train, and
the clutch mechanism is provided inside the conical shaped inside space of the retainer.

4. A lubricant discharging mechanism of a clutch apparatus for a transmission according to claim 2, wherein
the retainer includes a conical shaped inside space,
a narrower side of the conical shaped inside space of the retainer is oriented to the clutch mechanism and a wider side of the conical shaped inside space of the retainer is oriented to the gear train, and
the clutch mechanism is provided inside the conical shaped inside space of the retainer.

5. A lubricant discharging mechanism of a clutch apparatus for a transmission according to claim 1, wherein
a plurality of bores is formed at the outer circumferential portion of the retainer along an outer circumference of the clutch mechanism.

6. A lubricant discharging mechanism of a clutch apparatus for a transmission according to claim 1, wherein
a clutch drum is provided at an outer circumferential side of the clutch mechanism, and
the retainer is assembled onto the clutch drum.

7. A lubricant discharging mechanism of a clutch apparatus for a transmission according to claim 1, wherein
the guide member is provided at the outside of the retainer so as to extend from the retainer to a separator dividing the transmission case to the clutch housing and the gear train housing and is located at a lower side of the bore of the retainer,
the guide member includes an arc shape in a circumferential direction of the clutch mechanism, and
a plurality of discharge openings is formed at the separator at positions respectively corresponding to both end portions of the arc shape of the guide member

8. A lubricant discharging mechanism of a clutch apparatus for a transmission according to claim 7, wherein
the guide member further includes a plurality of gutter portions respectively provided at the end portions of the arc shape of the guide member and extending from the retainer to the separator, and
the plurality of gutter portions respectively faces the plurality of discharge openings,
whereby the lubricant discharged from the retainer through the bore is received by the gutter portions of the guide member to be guided towards the gear train and is supplied to the gear train through the discharge openings.

9. A lubricant discharging mechanism of a clutch apparatus for a transmission according to claim 1, wherein
the bore formed at the outer circumferential portion of the retainer is located at an upper side of an input shaft of the gear train, and
the guide member connected to the retainer is located at an upper side of the input shaft and at a lower side of the bore of the retainer.

10. A lubricant discharging mechanism of a clutch apparatus for a transmission according to claim 5, wherein
the plurality of bores is located at an upper side of an input shaft of the gear train, and
the guide member connected to the retainer is located at an upper side of the input shaft and at a lower side of the plurality of bores of the retainer.
